(19) United States
(12) Patent Application Publication
(10) Pub. No.: US 2017/0326545 A1
(43) Pub. Date: Nov. 16, 2017

(54) REINFORCED MICROPLATE

(71) Applicant: Corning Incorporated, Corning, NY (US)

(72) Inventors: Manman Kang, Freemont, CA (US); Wai Kin Poon, Union City, CA (US)

(21) Appl. No.: 15/533,680

(22) PCT Filed: Dec. 9, 2015
(86) PCT No.: PCT/US2015/064585

§ 371 Date: Jun. 7, 2017

Related U.S. Application Data
(60) Provisional application No. 62/090,066, filed on Dec. 10, 2014.

(51) Int. Cl. B01L 3/00

(52) U.S. Cl. CPC B01L 3/50851; B01L 2300/168; B01L 2200/12; B01L 2300/0829; B01L 2300/0848

(57) ABSTRACT

A reinforced microplate has reinforcing members that enhance stiffness and minimize deformation of the microplate, especially thermally-induced deformation. The reinforcing members include ribs or struts that are integrally formed on a bottom surface of the microplate. In cooperation with the reinforcing members, the microplate frame can include one or more slots that act to disrupt the effects of thermal expansion and limit thermally-induced strain.

This application claims the benefit of priority under 35 U.S.C. §119 of U.S. Provisional Application Ser. No. 62/090,066 filed on Dec. 10, 2014 the content of which is relied upon and incorporated herein by reference in its entirety.

### BACKGROUND

### Field

The present disclosure relates generally to microtiter plates, also known as microplates, and more particularly to reinforced microplates and their methods of manufacture. The reinforced microplates are adapted for use with automated equipment and can withstand thermal cycling without unacceptable deformation.

### Technical Background

Polymerase chain reaction (PCR) processes involve the replication of genetic material such as DNA and RNA. In both industry and academia, PCR processes are carried out on a large scale using multi-well microplates (e.g., 8 well strips or 96, 384 or even 1536 well arrays). It is desirable to have an apparatus that allows the PCR process to be performed in an efficient and convenient fashion.

Because of their ease of handling and relatively low cost, microplates are often used for sample containment during the PCR process. Microplates may also be used in other research and clinical diagnostic procedures. Reference is made to FIGS. 1A-1C where there are illustrated different views of an example microplate 100. Microplate 100 is formed from a polymeric material (e.g., polypropylene) and includes a body 106 having formed therein an array of conical or bullet-shaped wells 102 each configured to contain a small sample volume. Polypropylene has few extractables to interfere with the PCR process.

In accordance with the PCR process, a small quantity of genetic material and a solution of reactants are deposited within each well 102. The microplate 100 is then placed in a thermocycler, which operates to increase and decrease the temperature of the contents within the wells. In an example PCR process, the microplate 100 is placed on a metal heating fixture within the thermocycler. To provide good thermal contact and precise temperature control, the heating fixture is sized and shaped to closely conform to the underside of the microplate 100 and, in particular, to the exterior surface portion of the wells 102. A heated top plate of the thermocycler clamps the microplate onto the heating fixture while the well contents are repeatedly heated and cooled.

Because the microplate 100 is typically made from a non-thermally conductive polymeric material, the walls 105 of the wells 102 are configured to be as thin as possible in order that the thermocycler can effectively heat and cool the well contents. As a result, however, the relatively thin well walls 105 are inclined to deform in response to the repeated thermal cycling. In addition, the plate body may deform and even thermally degrade. Such degradation may further contribute to waiving or twisting of the plate. In order to accommodate the deformation, conventional microplates are formed using relatively non-rigid materials such as polypropylene. Unfortunately, polypropylene tends to strain in response to thermally-induced stress.

As a result of the deformation of the relatively thin well walls 104 and the tendency of the microplate body 106 to change dimensions during thermal cycling, it may be difficult to remove a traditional microplate from the thermocycler. Notably, as the number of wells 102 (and the overall size) of the microplate 100 increases, the force required to remove a deformed microplate 100 from the thermocycler increases, which may cause further damage. Moreover, robotic handling systems may have difficulty manipulating the microplate 100 and removing it from the thermocycler.

Accordingly, there is a need for a microplate free of the aforementioned shortcomings.

### BRIEF SUMMARY

In accordance with embodiments of the present disclosure, a microplate is provided comprising a body having a first surface and an opposing second surface defining a deck, the body including a plurality of wells formed in the deck and extending from the second surface, a frame peripheral to the plurality of wells, and a plurality of reinforcing ribs formed integral to the body and extending from the second surface. Optionally, a stress-relieving slot may be formed in each opposing length of the frame.

Additional features and advantages of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIGS. 1A-1C respectively illustrate a perspective view, a cut-away partial perspective view, and a cross-sectional side view of a microplate;

FIG. 2 is a perspective view of an example thermocycler capable of heating and cooling the microplates disclosed herein;

FIG. 3 is a plan view of an example reinforced microplate;

FIG. 4A-4B are cross-sectional views of the reinforced microplate of FIG. 3;

FIG. 5A-5B are detailed cross-sectional views of the reinforced microplate of FIG. 3;

FIG. 6 is a detailed plan view of a corner of the reinforced microplate of FIG. 3;

FIG. 7 is a detailed plan view of an edge of the reinforced microplate of FIG. 3;

FIG. 8 is a top perspective view of a reinforced microplate including an edge slot;

FIG. 9 is a bottom perspective view of the reinforced microplate of FIG. 8; and

FIG. 10 is an optical micrograph comparing the thermal response for a conventional microplate to a reinforced microplate.

### DETAILED DESCRIPTION

Reference will now be made in greater detail to various embodiments of the subject matter of the present disclosure, some embodiments of which are illustrated in the accompanying drawings. The same reference numerals will be used throughout the drawings to refer to the same or similar parts.

A microplate comprises a unitary body having reinforcing features that enhance stiffness and minimize deformation of the microplate, especially thermally-induced deformation. The reinforcing features include ribs or struts that are integrally formed on a bottom surface of the microplate. Further, the frame of the microplate can include one or more slots that disrupt the effects of thermal expansion and limit thermally-induced strain. In embodiments, the microplate is made by injection molding in a 1-shot process and thus comprises a single polymer material. The slots may be formed in situ, i.e., via the molding process. Alternatively, the slots may be formed after molding the microplate such as by cutting the frame.

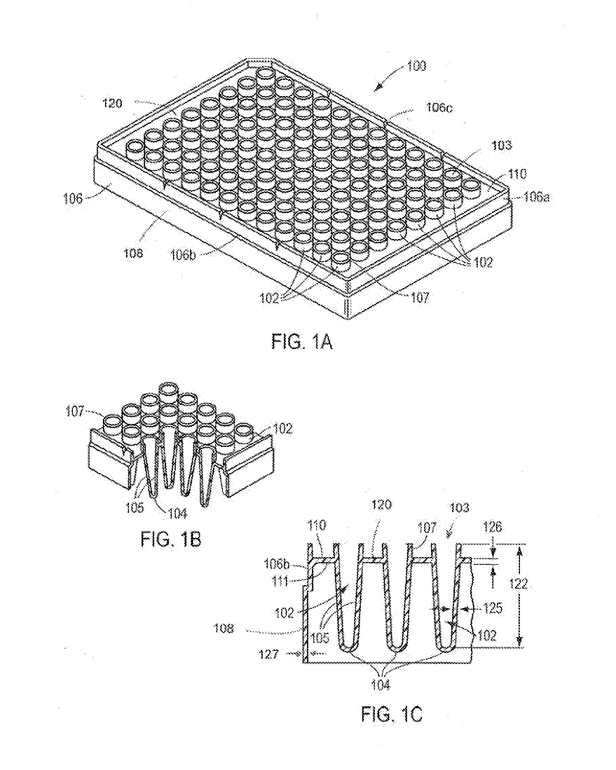

Referring again to FIGS. 1A-1C, there are illustrated different views of an exemplary microplate 100. The microplate 100 includes a body 106 that is manufactured from a polymeric material. The body 106 as shown has a rectangular shape having major and minor lengths and includes a top surface 110 bordered by a frame 108 oriented substantially orthogonal to the top surface. The thickness 127 of the frame 108 is defined as the distance between opposing surfaces of the frame along a line substantially perpendicular to the opposing surfaces.

The body 106 may have a substantially planar top surface 110 and an opposing bottom surface 111 defining a deck 120 having a thickness. The bottom surface may be substantially planar. The thickness 126 of the deck 120 is defined as the distance between the top surface 110 and the bottom surface 111 along a line substantially perpendicular to a major plane of the top surface 110.

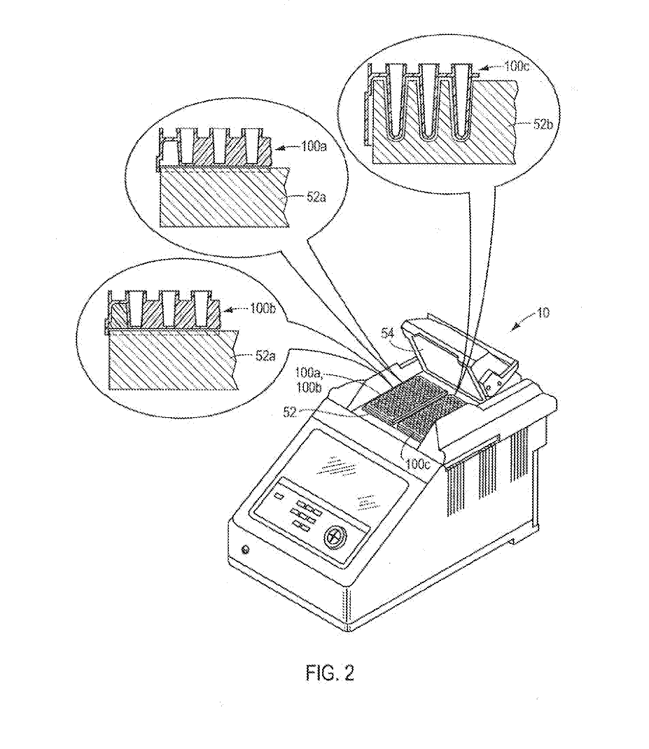

In the illustrated embodiment, the microplate 100 includes an array of ninety-six wells 102 formed in the deck 120 and extending downwardly from the bottom surface 111. The microplate is configured to be placed within a thermocycler as described in greater detail below with reference to FIG. 2. It should be understood that the body 106 can be provided in any number of other geometrical shapes (e.g., square or triangular) depending, for example, on the desired arrangement of the wells and the design of the thermocycler.

Each of the plurality of wells 102 includes a well opening 103, an opposing well bottom 104, and a well wall 105 defining a well volume between the opening 103 and the bottom 104. In embodiments, raised ridges 107 extend from the top surface 110 peripheral to each well opening 103. The ridges 107, if provided, may be used to form a seal for each well 102 during a thermocycling process.

The microplate may include any number of wells, e.g., 2 or more wells, for example 9, 16, 20, 30, 36, 96, 384 or 1536 wells. The wells 102 may be arranged in a close packed array or in a regular array of rows and columns. In the illustrated embodiments, the wells in each row and/or column are substantially aligned with wells in adjacent rows and/or adjacent columns. In other embodiments, the wells in each row and/or column are offset from wells in adjacent rows and/or adjacent columns. The embodiments illustrated in FIG. 1A-1C, for example, show a microplate 100 comprising plural wells arranged in an 8×12 array with the wells 102 in each row substantially aligned with wells in adjacent rows and the wells in each column substantially aligned with wells in adjacent columns.

The well openings 103 can have any suitable geometric shape. Non-limiting examples of suitable well opening shapes include polygonal, triangular, quadrangular, rectangular, square, trapezoidal, rhomboidal, pentagonal, hexagonal, heptagonal, octagonal, nonagonal, decagonal, circular, ovoid, ellipsoid, and curvilinear polygonal. In various embodiments, at least one well 102 has a well opening 103 having a shape in common with at least one other well of the plurality of wells. In some embodiments, each well 102 has a well opening 103 having the same shape as every other well of the plurality of wells. In other embodiments, each well 102 of the plurality of wells has a well opening 103 having a unique shape. In the embodiments illustrated in FIGS. 1A-1C, each well 102 has a well opening 103 that is substantially circular.

Microplate 100 may optionally include a peripheral apron 106a extending upwardly from the top surface 110. In some embodiments, at least a portion of the apron 106a extends substantially perpendicular to the top surface 110. In other embodiments, at least a portion of the apron 106a extends at an angle greater than or less than 90° with respect to the top surface 110 of the deck 120. In some embodiments, the apron 106a can accommodate a skirt of a microplate cover. In other embodiments, the microplate 100 does not include an apron 106a.

The apron 106a, if provided, may include an outer rim 106b. In various embodiments, at least a portion of the outer rim 106b extends along a periphery of the free edge of the apron 106a. In other embodiments, the apron does not include an outer rim 106b.

In various embodiments, the microplate 100 may optionally include one or more alignment features for purposes of aligning the microplate main body 100 within another device, for example a gripping device, a handling system, a thermocycler, or a storage device. According to certain embodiments, such features are chosen from cutouts, protrusions, and combinations thereof. In the embodiments illustrated in FIGS. 1A-1C, for example, apron 106b includes a plurality of spaced alignment notches 106c.

The wells 102 may have any suitable shape configured to contain a desired fluid volume. In various embodiments, the shape of the wells is defined principally by the well wall 105. Non-limiting examples of well shapes includes conical, frustoconical, rounded conical, right or oblique pyramidal, right or oblique frustopyramidal, cylindrical, cylindrical with a rounded end, right or oblique prism shaped, uniform or nonuniform prism shaped, bullet-shaped, and combinations thereof.

In various embodiments, at least one well 102 has at least one plane of symmetry. In some embodiments, the at least one plane of symmetry includes a major axis of the well 102. The major axis extends from a center of the well opening 103 to the nadir of the well bottom 104, for example. In some embodiments, at least one well 102 is radially symmetric about the major axis of the well 102. Other embodiments include at least one well 102 that lacks a plane of symmetry. In some embodiments, the well 102 has a cross-section taken along a plane substantially perpendicular to the major axis of the well that is substantially the same shape over the depth of the well 102. In other embodiments, the well 102 has a cross-section taken along a plane substantially perpendicular to the major axis of the well that varies over the depth of the well 102. In some embodiments, as shown in FIGS. 1A and 1B for example, each well 102 has a circular cross-section taken along a plane substantially perpendicular to the major axis of the well.

Non-limiting methods for forming the microplate include injection molding, injection compression molding, vacuum formation with a female mold and a male plug assist, and combinations thereof. In embodiments, the microplate is molded from a single polymer material in a single (1-shot) molding step such that the microplate body comprises wells and reinforcing members that are formed integral to the body. Such a microplate is free of any over-molded or attached components.

The microplate 100 may comprise a polymeric material. In various embodiments, the polymeric material has at least one characteristic chosen from being biologically inert, being chemically inert, having low biological reactivity, being thermoplastic, being moldable, being re-moldable, having low extractables, being optically transparent, being optically translucent, being IR transparent, and being UV transparent. In some embodiments, the microplate body 100 is formed from polycarbonate, polystyrene, polypropylene, polyvinyl chloride, polyethylene terephthalate, cyclo-olefins, or combinations thereof, which are thermoplastic, moldable, re-moldable, chemically inert, optically translucent or transparent, and have low extractables.

Many of the foregoing materials may have low working temperatures, however, and thus the microplate 100 if not suitably designed may deform or undergo other undesirable effects during or after the thermocycling process. Deformation may include warping, twisting, or other deviations from the original planar conformation of the top surface 110.

In addition, as noted previously, some polymeric materials, for example polypropylene, may strain in response to thermally-induced stress. Further, some polymeric materials, including polypropylene, can harbor residual stress from non-uniform cooling following a molding process, for example an injection molding process. The thermally-induced stress and/or the residual stress may result in deformation of the microplate during or after the thermocycling process.

As a result of the deformation of the microplate 100 during thermal cycling, it may be difficult to remove a microplate main body 100 from a thermocycler, as deformation from the original planar conformation can result in changes in the overall dimensions of the microplate, which in turn exceed the tolerances of the microplate in operation. As the number of wells 102 (and the overall size) of the microplate 100 increases, the force required to remove the microplate 100 from the thermocycler may increase, which may further damage the microplate. Moreover, robotic handling systems may have difficulty manipulating and/or removing a deformed microplate from the thermocycler. In addition, the microplate material may thermally degrade as a result of the thermal cycling. Such degradation may further contribute to warping or twisting of the microplate.

Referring to FIG. 2, there is a perspective view of an exemplary thermocycler 10 capable of heating and cooling the well contents of one or more microplates 100a, 100b, 100c, etc. In accordance with the PCR process, a small quantity of genetic material and a solution of reactants are deposited within one or more microplate wells. Optionally, the microplate is covered or sealed to inhibit the evaporation of the contents within the wells. Thereafter, the reinforced microplate is placed in the thermocycler 10, which operates to cycle the temperature of (i.e., repeatedly heat and cool) the content within the wells.

As illustrated, reinforced microplates 100a, 100b are positioned onto a metal heating fixture 52 such as heating fixture 52a in the example of a MJ Alpha-1200 thermocycler. The metal heating fixture 52a can be relatively flat to conform to flat-bottomed wells. In a further embodiment, a reinforced microplate 100c can be positioned onto a metal heating fixture 52b such as in the example of a GeneAmp® PCR System 9700. The metal heating fixture 52b has a series of cavities that are shaped to closely conform to the exterior dimensions of the wells.

The thermocycler 10 also has a heated top plate 54 (shown in the open position) that clamps the reinforced microplates 100a, 100b, 100c onto the metal heating fixtures 52a, 52b before the thermocycler repeatedly heats and cools the well contents. For instance, the thermocycler 10 can cycle the temperature of the contents within the wells over a temperature range of 25° C. to 95° C. as many as thirty times during the PCR process, which may have duration of up to 4 hours, e.g., 0.5, 1, 2, 3, or 4 hrs. During a typical PCR process, the temperature of the top plate is held constant (e.g., 100° C.) to minimize condensation while the temperature of the heating fixture is cycled. This temperature differential may exacerbate distortion or warping of the PCR plate.

According to various disclosed embodiments, the microplates comprise a reinforced structure that may include regions of different thicknesses. A microplate comprises a deck 120 having a deck thickness 126, a frame 108 having a frame thickness 127, and a plurality of wells 102, each well having a well wall thickness 125. In embodiments, the frame thickness is greater than or equal to the deck thickness, e.g., the frame thickness can be 1, 1.1, 1.2, 1.3, 1.4, 1.5, 2, 2.5 or 3 times the deck thickness, including ranges between any of the foregoing. In embodiments, the deck thickness is greater than or equal to the well wall thickness, e.g., the deck thickness can be 1, 1.1, 1.2, 1.3, 1.4, 1.5, 2, 2.5 or 3 times the well wall thickness, including ranges between any of the foregoing. According to various embodiments of the disclosure, the frame thickness is greater than the deck thickness and the deck thickness is greater than the well wall thickness.

Thinner well walls 105 and/or well bottoms 104 may allow for improved thermal conductivity, while a thicker frame 108 may aid in resisting or reducing undesired deformation of the microplate 100. As such, the use of a microplate having regions of different thicknesses may facilitate handling of the microplate by a scientist or robotic handling system, for example to remove the microplate from the thermocycler after completion of a PCR process.

The microplate, in embodiments, includes a plurality of reinforcing rib members 130 that project downwardly (e.g., orthogonally) from the plane of the bottom surface 111. The reinforcing rib members 130 may be characterized by a height from the bottom surface 111, a length, and a width (i.e., thickness). One or more of the height, length and width of a first rib member may be the equal to or different than one or more of the height, length and width of a second rib member. The height of a reinforcing rib member may range, for example, from 0.02 to 0.25 inches, e.g., 0.02, 0.03, 0.04, 0.05, 0.1, 0.15, 0.2 or 0.25 inches, including ranges between any of the foregoing values. The width of a reinforcing rib member may range, for example, from 0.01 to 0.09 inches, e.g., 0.01, 0.02, 0.03, 0.04, 0.05, 0.06, 0.07, 0.08 and 0.09 inches, including ranges between any of the foregoing values.

Portions of the rib members 130 may intersect with one another to form a corrugated-type reinforcing network at an underside of the microplate, i.e., the rib members are arranged in folds or alternate furrows and ridges. Plural rib members may be disposed on the deck bottom surface peripheral to the well array. Rib members located peripheral to the well array may be arranged with a length that is parallel to, orthogonal to, and/or at an oblique angle to the major or minor lengths of the microplate. For instance, one or more rib members may be configured to form one or more continuous or semi-continuous loops that extend along a periphery of the microplate. Plural loops may be concentric. A semi-continuous loop may be interrupted at one or more points along its length. An example distance from an outer edge of the microplate to a peripheral rib member may range from ⅛ inch to ⅜ inch, for example.

In addition to or in lieu of such an arrangement, rib members may be disposed between wells, i.e., between the rows and/or columns of wells. Such rib members may be arranged with a length that is parallel to a close packed, row or column direction of the well array, i.e., arranged as substantially linear segments. The rib members essentially form regions of the deck that are locally thicker (i.e., by an amount equal to the height of the rib member).

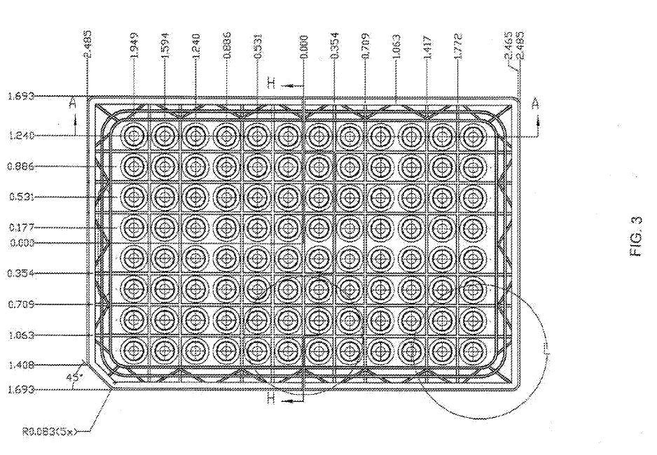

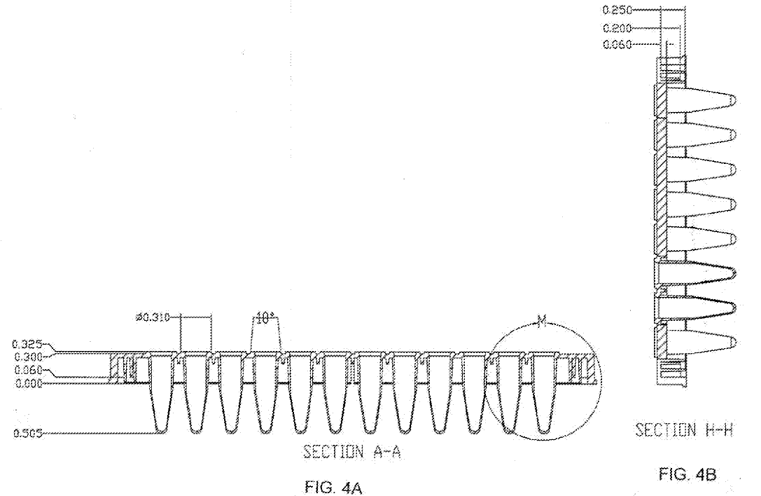

Additional aspects of the reinforced microplates, which include reinforcing ribs, are disclosed herein with reference to the engineering drawings of FIGS. 3-7 where length measurements are given in inches.

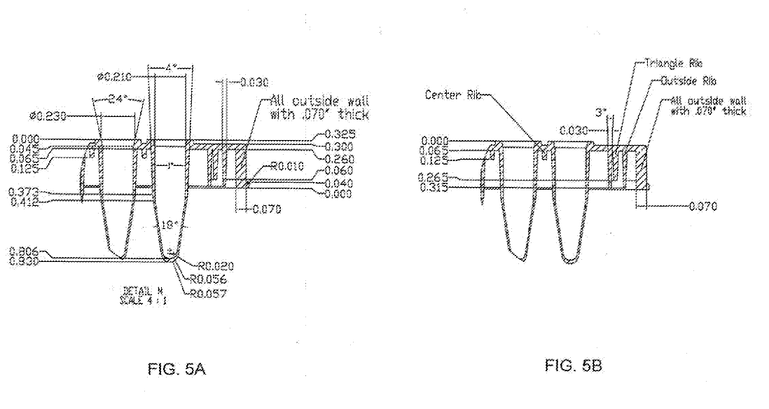

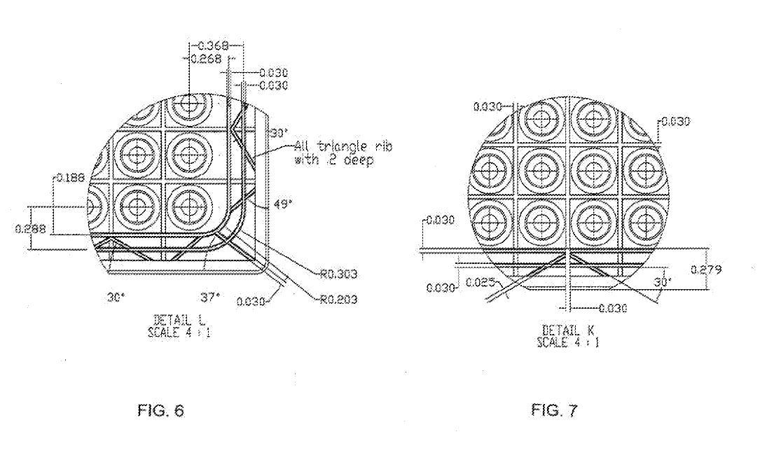

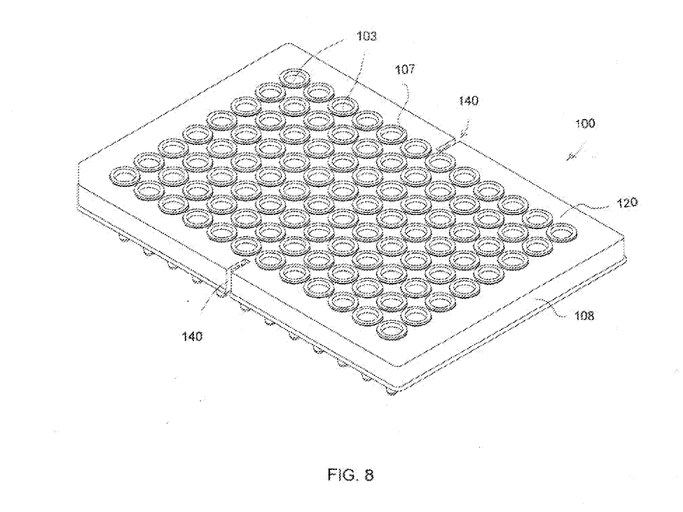

FIG. 3 is a bottom plan view of a reinforced microplate 100 having a network of peripheral rib members 130. Corresponding cross-sectional views A-A and H-H are depicted in FIGS. 4A and 4B, respectively. Detailed views of Section M from FIG. 4A are depicted in FIGS. 5A and 5B. Detailed views of Sections L and K from FIG. 3 are shown in FIGS. 6 and 7.

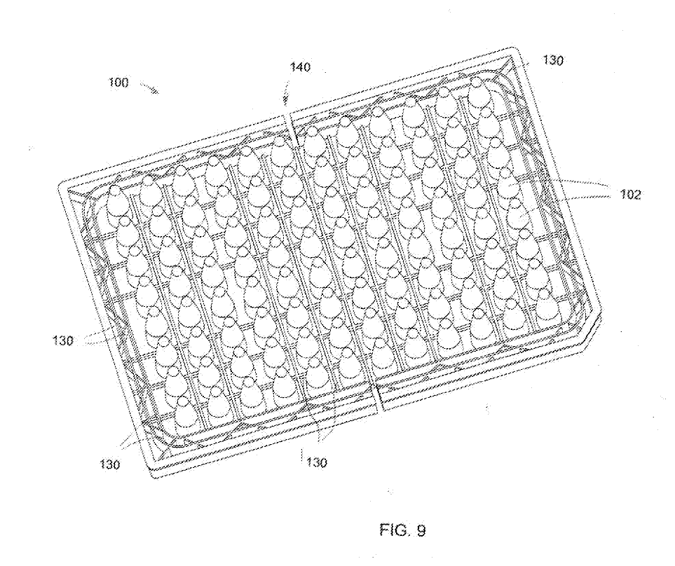

In embodiments, the microplate frame 108 includes one or more slots 140 that cut completely through the frame 108. In embodiments, the one or more slots cut completely through peripheral rib members. By way of example, and with reference to FIGS. 8 and 9, which are respectively top and bottom perspective views, a reinforced microplate 100 can include a pair of slots 140 each formed in an opposing relationship in a respective major length of the frame 108, such as at a midpoint of the major length.

The incorporation of the slots 140 into the frame facilitates the release of stress in the microplate, particularly in a microplate exhibiting a complicated stress state due to differences in, inter alia, the shape and thickness of the part, as well as local temperature differences. Without wishing to be bound by theory, the slots 140 permit thermal expansion within the frame without the accumulation of stress that could otherwise deform the microplate.

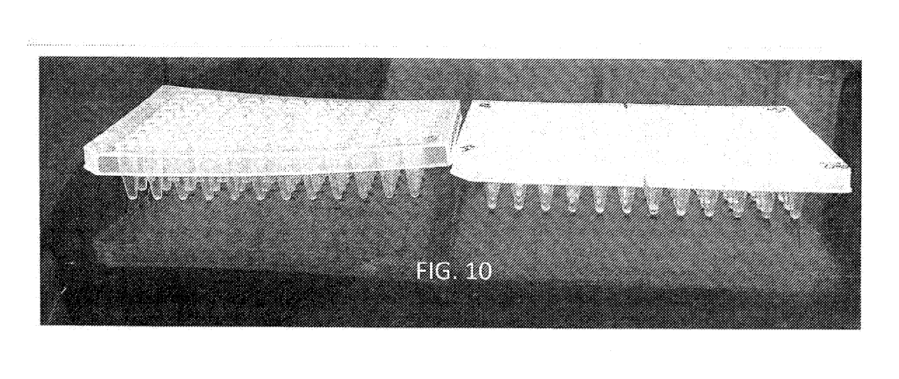

Testing in a thermocycler has shown that the deformation of a reinforced polypropylene microplate is reduced by 80% in comparison to a convention (non-reinforced) polypropylene microplate. FIG. 10 is an optical micrograph comparing the thermal cycling response of a conventional polypropylene microplate (left) to a reinforced polypropylene microplate (right). Warping is clearly evident in the conventional polypropylene microplate, in contrast to the reinforced microplate.

The use of a reinforced microplate having a rigid structure makes it easy for a scientist or robot handling system to remove the microplate from the thermocycler after completion of the PCR process. This is a marked improvement over the traditional microplate that has a tendency to deform and/or adhere to the metal heating fixtures 52a/52b.

Although the reinforced microplate is described as being used in a PCR process, it should be understood that the reinforced microplate can be used in a wide variety of processes. A reinforced PCR plate may be non-skirted, semi-skirted, or a full-skirted plate.

In embodiments, the microplate 100 is formed from a transparent material. As used herein, “transparent” means at least 60% transparency (e.g., at least 60, 65, 70, 75, 80, 82, 84, 86, 88, 90, 92, 94, 96, 98, 99 or 100% transparency) for a given wavelength or over a range of wavelengths. In embodiments, for example, the well walls are transparent to visible light (i.e., over the wavelength range of 390 to 700 nm). In embodiments, the well walls are transparent to ultraviolet and/or near-infrared radiation (i.e., over the respective wavelength ranges of 100 to <390 nm and >700 to 2500 nm).

In embodiments, the well walls are characterized by low background fluorescence. Fluorescence is a form of absorbed energy that is rerachated at a lower energy, often as light. The amount of fluorescence (or lack thereof) from reinforced microplates is a key factor in their implementation with, for example, analytical spectroscopy, polarization and imaging, including point-of-care (POC) in vitro diagnostic tests, and other life-sciences analytics such as cellular flow cytometry.

Disclosed herein is a reinforced microplate such as a PCR plate. The reinforced microplate may be formed from a single polymer material in a 1-shot molding process. As such, the microplate is readily recyclable and less expensive to manufacture than comparative plates formed in plural steps and/or which include plural polymer materials. The microplate includes reinforcing ribs that are incorporated onto the bottom surface of the microplate deck. Stress-relieving slots may be formed in the frame of the reinforced microplate.

As used herein, the singular forms “a,” “an” and “the” include plural referents unless the context clearly dictates otherwise. Thus, for example, reference to a “notch” includes examples having two or more such “notches” unless the context clearly indicates otherwise

The term “include” or “includes” means encompassing but not limited to, that is, inclusive and not exclusive.

“Optional” or “optionally” means that the subsequently described event, circumstance, or component, can or cannot occur, and that the description includes instances where the event, circumstance, or component, occurs and instances where it does not.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. For example, implied alternative embodiments to a microplate comprising polypropylene include embodiments where a microplate consists of polypropylene and embodiments where a microplate consists essentially of polypropylene.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

1. A microplate comprising:
a body having a first surface and an opposing second surface defining a deck, the body including a plurality of wells formed in the deck and extending from the second surface, a frame peripheral to the plurality of wells, and a plurality of reinforcing ribs formed integral to the body and extending from the second surface.

2. The microplate according to claim 1, wherein the reinforcing ribs are formed peripheral to the plurality of wells.

3. The microplate according to claim 1, wherein the reinforcing ribs comprise alternate furrows and ridges.

4. The microplate according to claim 1, wherein the peripheral reinforcing ribs have a height greater than the deck thickness.

5. The microplate according to claim 1, wherein the reinforcing ribs extend between adjacent wells.

6. The microplate according to claim 5, wherein the reinforcing ribs extending between adjacent wells comprise linear segments.

7. The microplate according to claim 5, wherein the reinforcing ribs extending between adjacent wells have a height greater than the deck thickness.

8. The microplate according to claim 1, wherein the first surface is substantially planar.

9. The microplate according to claim 1, wherein the microplate is a PCR plate.

10. The microplate according to claim 1, wherein the body comprises polypropylene.

11. The microplate according to claim 1, wherein walls of the wells comprise an optically transparent material.

12. The microplate according to claim 1, wherein the frame thickness is greater than or equal to the deck thickness.

13. The microplate according to claim 1, wherein the deck thickness is greater than or equal to the well wall thickness.

14. The microplate according to claim 1, wherein the frame thickness is greater than the deck thickness and the deck thickness is greater than the well wall thickness.

15. The microplate according to claim 1, further comprising a slot formed in each opposing length of the frame.

16. The microplate according to claim 15, wherein the slots are formed in major lengths of the frame.

17. A method of forming a microplate according to claim 1, comprising:
injection molding a body having a first surface and an opposing second surface defining a deck, the body including a plurality of wells formed in the deck and extending from the second surface, a frame peripheral to the plurality of wells, and a plurality of reinforcing ribs formed integral to the body and extending from the second surface.
